(19) United States
(12) Patent Application Publication
(10) Pub. No.: US 2011/0161085 A1
(43) Pub. Date: Jun. 30, 2011

(54) METHOD AND APPARATUS FOR AUDIO SUMMARY OF ACTIVITY FOR USER

(75) Inventors: Peter BODA, Palo Alto, CA (US); Banu Dhanakoti, Woburn, MA (US)

(73) Assignee: Nokia Corporation, Espoo (FI)

(21) Appl. No.: 12/651,060

(22) Filed: Dec. 31, 2009

(51) Int. Cl. G10L 13/08; G06F 17/00

(52) U.S. Cl. 704/260; 700/94; 704/E13.011

(57) ABSTRACT

Techniques for audio summary of activity for a user include tracking activity at one or more network sources associated with a user. One audio stream that summarizes the activity over a particular time period is generated. The audio stream is caused to be delivered to a particular device associated with the user. A duration of a complete rendering of the audio stream is shorter than the particular time period. In some embodiments, a link to content related to at least a portion of the audio stream is also caused to be delivered for a user.

### BACKGROUND

Network service providers and device manufacturers are continually challenged to deliver value and convenience to consumers by, for example, providing compelling network services. Consumers utilize these network service channels to conduct an ever increasing portion of their daily activities, such as searching for information, communicating with others, keeping in touch easily and quickly with friends and family, conducting commercial transactions, and rendering content for job, home and recreation. As a consequence, a user is bombarded with so much information that it is difficult to recall at the end of a day what has transpired during that day.

### Some Example Embodiments

Therefore, there is a need for an approach for audio summary of activity of interest to a user that does not consume large amounts of device and network resources and that allows a user to receive the summary without active gazing, e.g., while watching children or operating equipment (e.g., driving a car) or while relaxing with closed eyes such as listening to a radio in bed in the evening.

According to one embodiment, a method comprises facilitating access, including granting access rights, to an interface to allow access to a service via a network. The service comprises tracking activity at one or more network sources associated with a user. The service also comprises generating one audio stream that summarizes the activity over a particular time period. A duration of a complete rendering of the audio stream is shorter than the particular time period over which the activity is summarized. The service also comprises causing the audio stream to be delivered to a particular device associated with the user.

According to another embodiment, an apparatus comprises at least one processor, and at least one memory including computer program code. The at least one memory and the computer program code are configured to, with the at least one processor, cause, at least in part, the apparatus to track activity at one or more network sources associated with a user. The apparatus is also caused to generate one audio stream that summarizes the activity over a particular time period. A duration of a complete rendering of the audio stream is shorter than the particular time period. The apparatus is further caused to cause the audio stream to be delivered to a particular device associated with the user.

According to another embodiment, a computer-readable storage medium carrying one or more sequences of one or more instructions which, when executed by one or more processors, cause, at least in part, an apparatus to track activity at one or more network sources associated with a user. The apparatus is also caused to generate one audio stream that summarizes the activity over a particular time period. A duration of a complete rendering of the audio stream is shorter than the particular time period. The apparatus is further caused to cause the audio stream to be delivered to a particular device associated with the user.

According to another embodiment, an apparatus comprises means for tracking activity at one or more network sources associated with a user. The apparatus also comprises means for generating one audio stream that summarizes the activity over a particular time period. A duration of a complete rendering of the audio stream is shorter than to the particular time period. The apparatus further comprises means for causing the audio stream to be delivered to a particular device associated with the user.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing an audio summary of activity for a user, according to one embodiment;

FIG. 2 is a diagram of the components of an audio interface unit, according to one embodiment;

FIG. 3 is a time sequence diagram that illustrates example input and audio output signals at an audio interface unit, according to an embodiment;

FIG. 4 is a diagram of components of a personal audio service module with an activity summary service module, according to an embodiment;

FIG. 5A is a diagram that illustrates activity data in a message or data structure, according to an embodiment;

FIG. 5B is a time sequence diagram that illustrates an audio summary of activity, according to an embodiment;

FIG. 5C is a diagram that illustrates an example activity statistics data structure, according to one embodiment;

FIG. 6A is a flowchart of a server process for providing an audio summary of activity for a user, according to one embodiment;

FIG. 6B is a flowchart of a process for performing one step of the method of FIG. 6A, according to one embodiment;

FIG. 6C is a flowchart of a process for performing another step of the method of FIG. 6A, according to one embodiment;

FIG. 7 is a flowchart of a client process for providing an audio summary of activity for a user, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program are disclosed for audio summary of activity for a user, i.e., one or more users. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term activity refers to data describing one or more actions performed by a person using a device that, at least sometimes, is connected to a network. Activity includes, for example, presence status information, context information, or physical activities like walking, sitting, driving, among others, or even social activities like a meeting, having a discussion, a business lunch, among others, alone or in some combination. This activity can be deduced in any manner known in the art, such as a motion sensor, audio sniffing, calendar item information, among others, alone or in some combination. The person may be a user or a person of interest to the user, such as a friend or a celebrity such as an actor, sports figure or politician. The network may be an ad hoc network formed opportunistically between devices or a more permanent network described below.

As used herein, content or media includes, for example, digital sound, songs, digital images, digital games, digital maps, point of interest information, digital videos, such as music videos, news clips and theatrical videos, advertisements, electronic books, presentations, program files or objects, any other digital media or content, or any combination thereof. The terms presenting and rendering each indicate any method for presenting the content to a human user, including playing audio or music through speakers, displaying images on a screen or in a projection or on tangible media such as photographic or plain paper, showing videos on a suitable display device with sound, graphing game or map data, or any other term of art for presentation, or any combination thereof. In many illustrated embodiments, a player is an example of a rendering module.

Although various embodiments are described with respect to delivering a summary to an audio interface unit, it is contemplated that the approach described herein may be used to deliver a summary to any device, such as a mobile phone, a personal digital assistant, an audio or video player, a fixed or mobile computer, a radio, or a television, a game device, a positioning device, an electronic book device, among others, alone or in some combination.

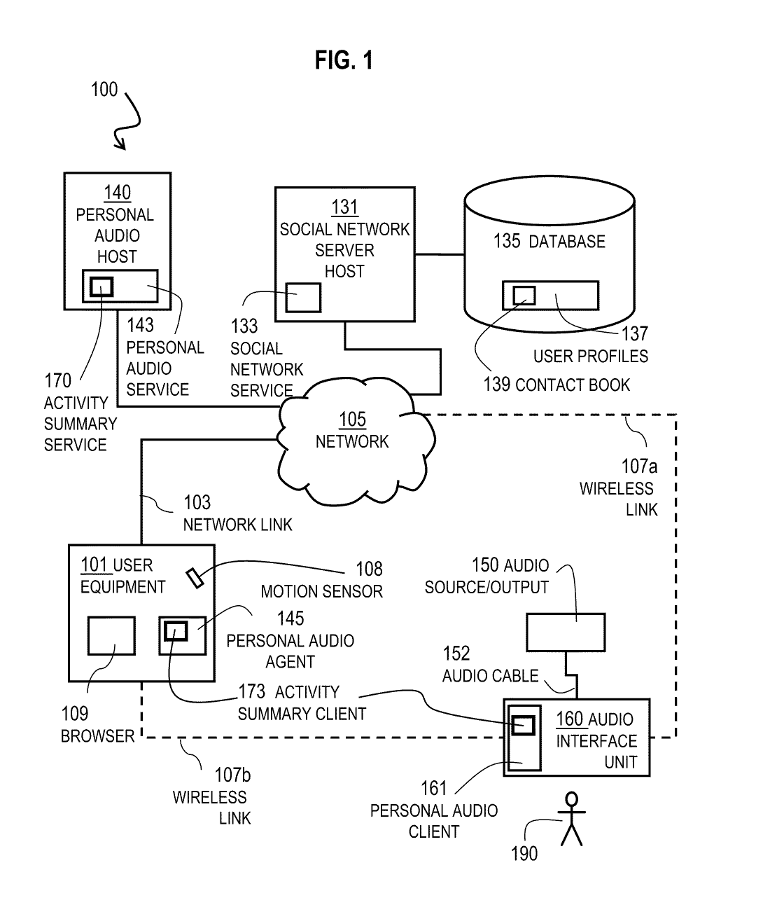

FIG. 1 is a diagram of a system 100 capable of providing an audio summary of activity for a user, according to one embodiment. As a user 190 engages in actions throughout the day the user is often accompanied by a device connected to a network, called herein a network device, such as a mobile telephone, a personal digital assistant (PDA), a notebook or laptop or desktop computer, an audio interface unit. Data generated at one or more network devices of the user or data communicated between the one or more network devices and the network can be mined to infer the user actions. However, this data is often not recorded, or recorded locally only on one device, or is recorded on disparate network services scattered over the network and is not available for any kind of daily summary of the user's actions. A log of actions on a single device is not effective if the user employs different network devices throughout the day, such as a workplace computer and a home computer, or an audio player different from a mobile telephone, or the summary is to include content on a network resource not visited from the single device. Also, the actions of the user are not generally available to friends or fans of the user. Having all resources send activity data to a central service is wasteful of network resources, when a user has interest in only a portion of that activity. Furthermore, such reporting can easily saturate the capacity of the central service.

To address this problem, the system 100 of FIG. 1 introduces the capability to aggregate and summarize all activity of interest to a user in an activity summary service on the network, for eventual delivery to a user device of choice and presentation as audio of short duration. To allow presentation as audio of short duration, summary text is derived from the aggregated activity of interest to a user and prioritized, in some embodiments. The highest priority summary text is converted to speech for presentation to the user within the short duration controlled by the user, e.g., less than a fixed amount, such as five minutes, or a duration adaptable to the amount of high priority activity to convey. In various embodiments, audio related to the activity is delivered as audio background to the speech, or links to content related to the activity or related to background audio are also made available for selection by the user, or some combination. In some embodiments, various aspects of the audio stream are configurable by the user, such as the duration of the audio stream, or a period of time over which activities are to be summarized, or indications of network sources of activities of interest, or friends or celebrities of interest, or a delivery schedule or condition, or a celebrity or other voice to use in the conversion from text to speech, or priorities for including various actions in the summary, or some combination.

As shown in FIG. 1, the system 100 comprises a user equipment (UE) 101 having connectivity to a personal audio service module 143 on a personal audio host 140 and connectivity to social network service module 133 on social network service host 131 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.). In some embodiments, UE 101 includes other sensors, such as a light sensor, a global positioning system (GPS) receiver, or an accelerometer or other motion sensor. In the illustrated embodiment, UE 101 includes motion sensor 108.

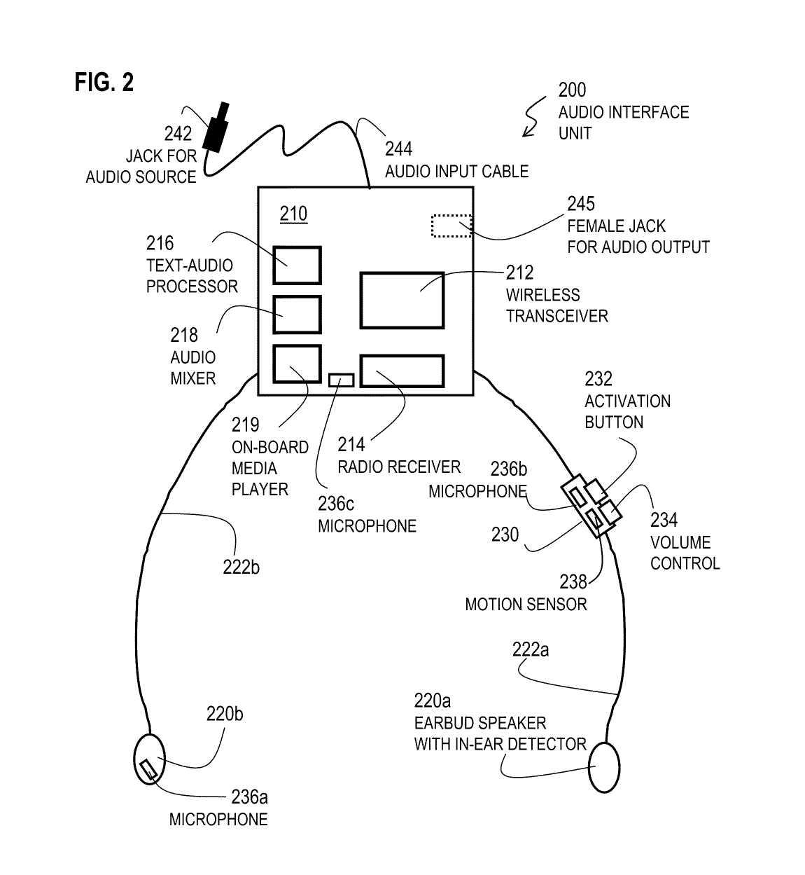

The audio interface unit 160 is a much trimmed down piece of user equipment with primarily audio input from, and audio output to, user 190. Example components of the audio interface unit 160 are described in more detail below with reference to FIG. 2. It is also contemplated that the audio interface unit 160 comprises “wearable” circuitry. In the illustrated embodiments, a portable audio source/output 150, such as a portable Moving Picture Experts Group Audio Layer 3 (MP3) player, as a local audio source is connected by audio cable 152 to the audio interface unit 160. In some embodiments, the audio source/output 150 is an audio output device, such as a set of one or more speakers in the user's home or car or other facility. In some embodiments, both an auxiliary audio input and auxiliary audio output are connected to audio interface unit 160 by two or more separate audio cables 152. In some embodiments, the audio interface unit 160 is an output device only, such as a frequency modulation (FM) radio, and the wireless link 107b is a transmission link only from UE 101, such as a FM radio transmission from UE 101.

By way of example, the UE 101, personal audio service 143, social network server 133 and audio interface unit 160 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Processes executing on various devices, such as on audio interface unit 160 and on personal audio host 140, often communicate using the client-server model of network communications. The client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host on which the process operates. Similarly, the term “client” is conventionally used to refer to the process that makes the request, or the host on which the process operates. As used herein, the terms “client” and “server” refer to the processes, rather than the hosts, unless otherwise clear from the context. In addition, the process performed by a server can be broken up to run as multiple processes on multiple hosts (sometimes called tiers) for reasons that include reliability, scalability, and redundancy, among others. A well known client process available on most nodes connected to a communications network is a World Wide Web client (called a “web browser,” or simply “browser”) that interacts through messages formatted according to the hypertext transfer protocol (HTTP) with any of a large number of servers called World Wide Web (WWW) servers that provide web pages

In the illustrated embodiment, the UE 101 includes a browser 109 for interacting with WWW servers included in the social network service module 133 on one or more social network server hosts 131, the personal audio service module 143, the activity summary service module 170 and other service modules on other hosts.

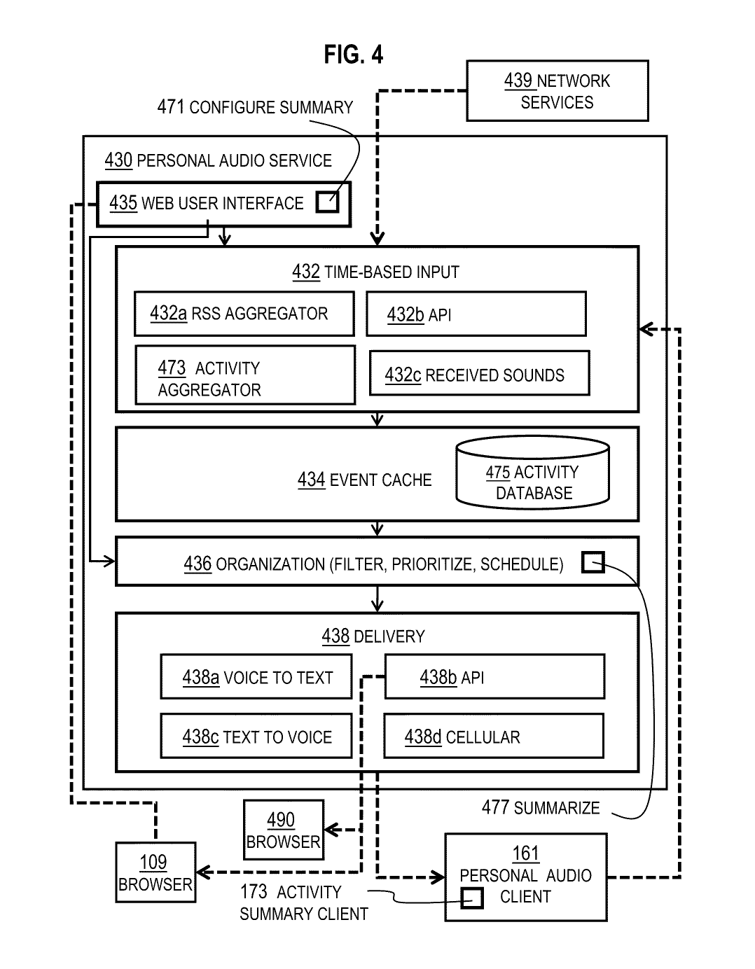

The illustrated embodiment includes a personal audio service module 143 on personal audio host 140. The personal audio service module 143 includes a Web server for interacting with browser 109 and also an audio server for interacting with a personal audio client 161 executing on the audio interface unit 160 as described in more detail below with reference to FIG. 4. The personal audio service 143 is configured to deliver audio data to the audio interface unit 160. In some embodiments, at least some of the audio data is based on data provided by other servers on the network, such as social network service 133. In the illustrated embodiment, the personal audio service 143 is configured for a particular user 190 by Web pages delivered to browser 109, for example to specify a particular audio interface unit 160 and what services are to be delivered as audio data to that unit. After configuration, user 190 input is received at personal audio service 143 from personal audio client 161 based o gestures or spoken words of user 190, and selected network services content is delivered from the personal audio service 143 to user 190 through audio data sent to personal audio client 161.

Many services are available to the user 190 of audio interface unit 160 through the personal audio service 143 via network 105, including social network service 133 on one or more social network server hosts 131. In the illustrated embodiment, the social network service 133 has access to database 135 that includes one or more data structures, such as user profiles data structure 137 that includes a contact book data structure 139. Information about each user who subscribes to the social network service 133 is stored in the user profiles data structure 137, and the name, telephone number, cell phone, number, email address or other network addresses, or some combination, of one or more persons whom the user contacts are stored in the contact book data structure 139.

In some embodiments, the audio interface unit 160 connects directly to network 105 via wireless link 107a (e.g., via a cellular telephone engine or a WLAN interface to a network access point). In some embodiments, the audio interface unit 160 connects to network 105 indirectly, through UE 101 (e.g., a cell phone or laptop computer) via wireless link 107b (e.g., a WPAN interface to a cell phone or laptop or a radio transmission only from UE 101). Network link 103 may be a wired or wireless link, or some combination. In some embodiments in which audio interface unit 160 relies on wireless link 107b, a personal audio agent process 145 executes on the UE 101 to transfer audio between the audio interface unit 160 sent by personal audio client 161 and the personal audio service 143, or to convert other data received at UE 101 to audio data for presentation to user 190 by personal audio client 161, or some combination.

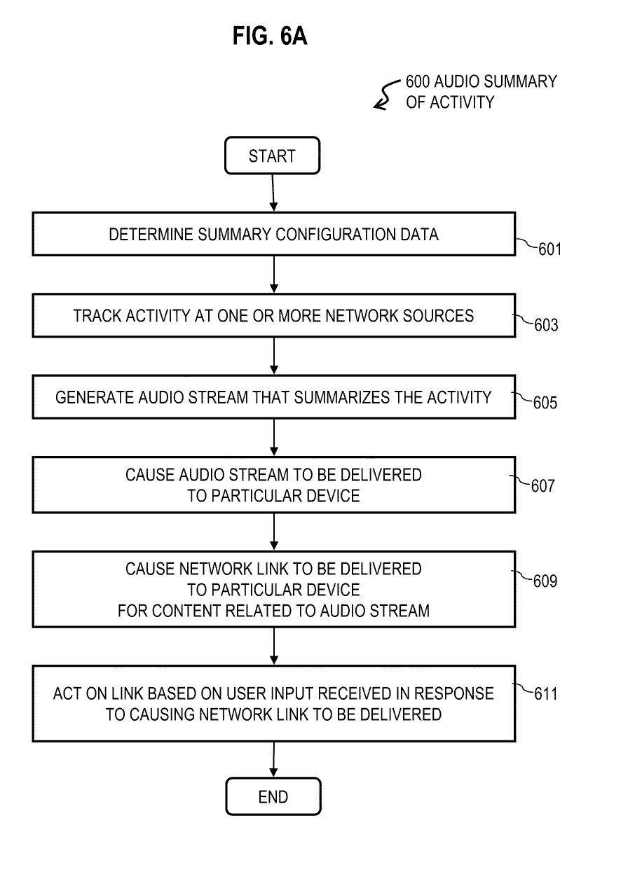

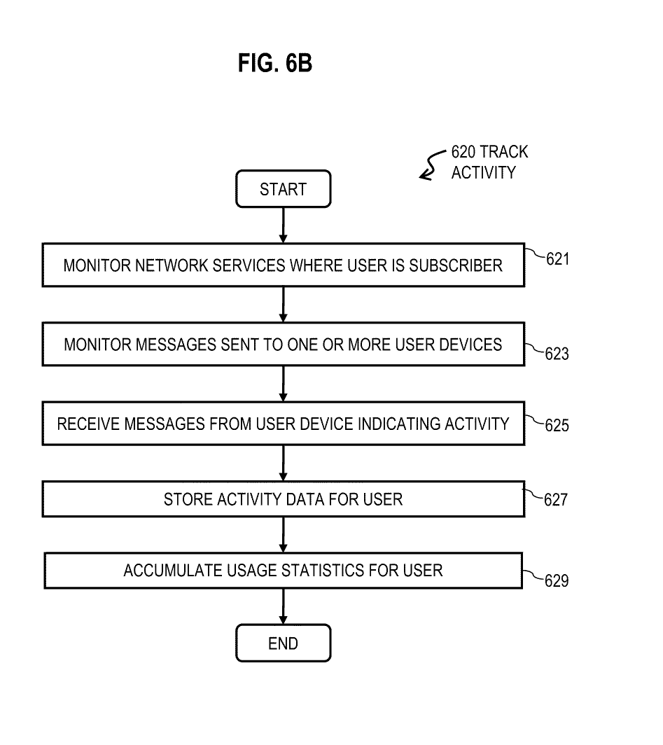

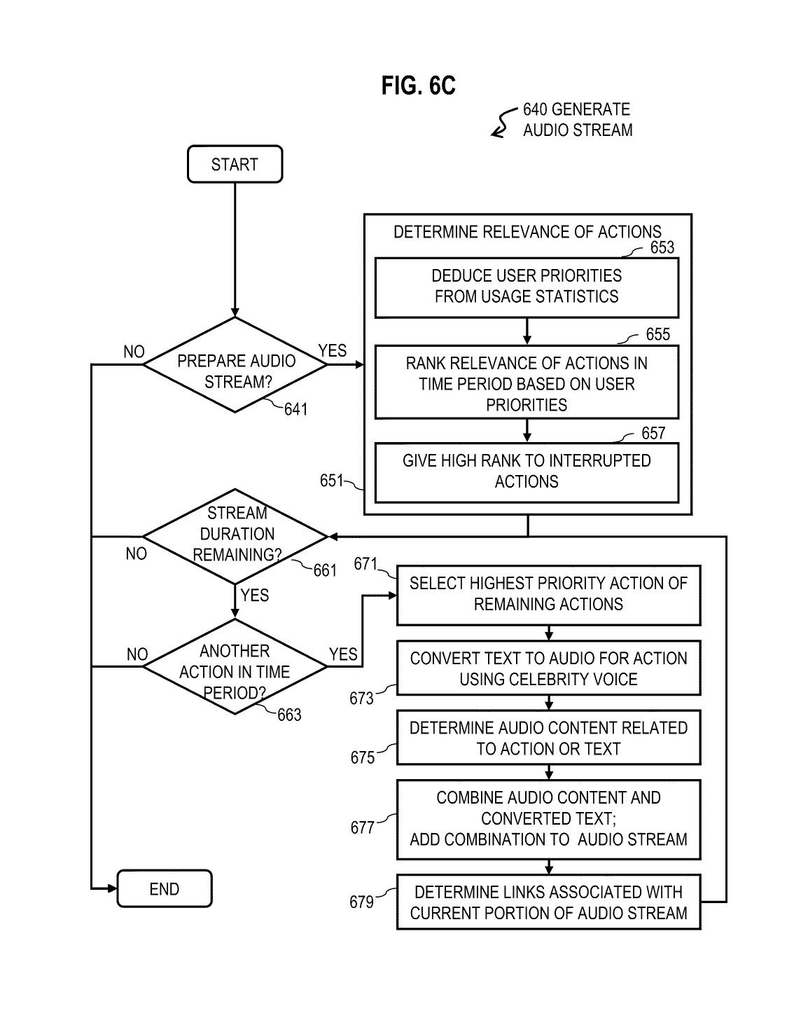

According to an illustrated embodiment, the personal audio service 143 includes an activity summary service 170 to aggregate and summarize activities for a user on one or more network sources, including one or more devices of user 190, as described in more detail below with reference to FIG. 6A, FIG. 6B and FIG. 6C. The summarized activity is converted to audio and delivered to user 190 at a user device, such as audio interface unit 160 or UE 101. In some embodiments, an activity summary client 173 executes on personal audio client 161 or personal audio agent 145 or browser 109 to report activity to the activity summary service 170 or receive the summary upon completion as an audio stream.

Although various hosts and processes and data structures are depicted in FIG. 1 and arranged in a particular way for purposes of illustration, in other embodiments, more or fewer hosts, processes and data structures are involved, or one or more of them, or portions thereof, are arranged in a different way, or one or more are omitted, or the system is changed in some combination of ways. Although user 190 is shown for purposes of illustration, user 190 is not part of system 100.

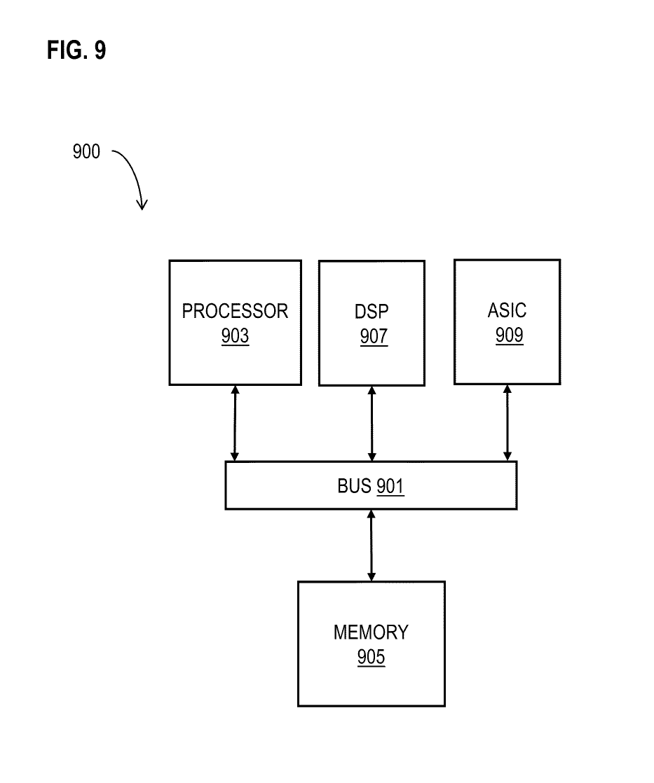

FIG. 2 is a diagram of the components of an example audio interface unit 200, according to one embodiment. Audio interface unit 200 is a particular embodiment of the audio interface unit 160 depicted in FIG. 1. By way of example, the audio interface unit 200 includes one or more components for providing audio summary of activity for a user to a user. It is contemplated that the functions of these components may be combined in one or more components, such as one or more chip sets depicted below and described with reference to FIG. 9, or performed by other components of equivalent functionality on one or more other nodes, such as user audio agent 145 on UE 101 or personal audio service 143 on host 140. In some embodiments, one or more of these components, or portions thereof, are omitted, or one or more additional components are included, or some combination of these changes is made.

In the illustrated embodiment, the audio interface unit 200 includes circuitry housing 210, stereo headset cables 222a and 222b (collectively referenced hereinafter as stereo cables 222), stereo speakers 220a and 220b configured to be worn in the ear of the user with in-ear detector (collectively referenced hereinafter as stereo earbud speakers 220), controller 230, and audio input cable 244.

In the illustrated embodiment, the stereo earbuds 220 include in-ear detectors that can detect whether the earbuds are positioned within an ear of a user. Any in-ear detectors known in the art may be used, including detectors based on motion sensors, heart-pulse sensors, light sensors, or temperature sensors, or some combination, among others. In some embodiments the earbuds do not include in-ear detectors. In some embodiments, one or both earbuds 220 include a microphone, such as microphone 236a, to pick up spoken sounds from the user. In some embodiments, stereo cables 222 and earbuds 220 are replaced by a single cable and earbud for a monaural audio interface.

The controller 230 includes an activation button 232 and a volume control element 234. In some embodiments, the controller 230 includes a microphone 236b instead of or in addition to the microphone 236a in one or more earbuds 220 or microphone 236c in circuitry housing 210. In some embodiments, the controller 230 includes a motion sensor 238, such as an accelerometer or gyroscope or both. In some embodiments, the controller 230 is integrated with the circuitry housing 210.

The activation button 232 is depressed by the user when the user wants sounds made by the user to be processed by the audio interface unit 200. Depressing the activation button to speak is effectively the same as turning the microphone on, wherever the microphone is located. In some embodiments, the button is depressed for the entire time the user wants the user's sounds to be processed; and is released when processing of those sounds is to cease. In some embodiments, the activation button 232 is depressed once to activate the microphone and a second time to turn it off. Some audio feedback is used in some of these embodiments to allow the user to know which action resulted from depressing the activation button 232. Voice Activity Detection and Keyword Spotting are example known technologies that identify whether there is human speech and whether a known command is uttered.

In some embodiment with an in-ear detector and a microphone 236a in the earbud 220b, the activation button 232 is omitted and the microphone is activated when the earbud is out and the sound level at the microphone 236a in the earbud 220b is above some threshold that is easily obtained when held to the user's lips while the user is speaking and which rules out background noise in the vicinity of the user.

An advantage of having the user depress the activation button 232 or take the earbud with microphone 236a out and hold that earbud near the user's mouth is that persons in sight of the user are notified that the user is busy speaking and, thus, is not to be disturbed.

In some embodiments, the user does not need to depress the activation button 232 or hold an earbud with microphone 236a; instead the microphone is always active but ignores all sounds until the user speaks a particular word or phrase, such as “Mike On,” that indicates the following sounds are to be processed by the unit 200, and speaks a different word or phrase, such as “Mike Off,” that indicates the following sounds are not to be processed by the unit 200. Some audio feedback is available to determine if the microphone is being processed or not, such as responding to a spoken word or phrase, such as “Mike,” with the current state “Mike on” or “Mike off.” An advantage of the spoken activation of the microphone is that the unit 200 can be operated completely hands-free so as not to interfere with any other task the user might be performing.

In some embodiments, the activation button doubles as a power-on/power-off switch, e.g., as indicated by a single depression to turn the unit on when the unit is off and by a quick succession of multiple depressions to turn off a unit that is on. In some embodiments, a separate power-on/power-off button (not shown) is included, e.g., on circuitry housing 210.

The volume control 234 is a toggle button or wheel used to increase or decrease the volume of sound in the earbuds 220. Any volume control known in the art may be used. In some embodiments the volume is controlled by the spoken word, while the sounds from the microphone are being processed, such as “Volume up” and “Volume down” and the volume control 234 is omitted. However, since volume of earbud speakers is changed infrequently, using a volume control 234 on occasion usually does not interfere with hands-free operation while performing another task.

In some embodiments, motions, such as hand gestures, detected by motion sensor 238 are used to indicate user input, in addition to or in place of any microphone 236. For example, a fast jerk upward indicates a selection by the user, a clockwise motions indicates fast forward of audio output, anticlockwise motion indicates reverse audio output, make a bookmark, send a quick message to a friend that “I am thinking of you” or “just listening what you've done today” etc. An advantage of motion detector input from a user is to reduce a need for keys and buttons to allow the user to interact and greatly simplifies the construction of the audio interface unit. Furthermore, such gesture detection is an eye-free interaction mode and can employ intuitive and natural hand gestures, or the user can define to his or her own preferences, using any method known in the art.

The circuitry housing 210 includes wireless transceiver 212, a radio receiver 214, a text-audio processor 216, an audio mixer module 218, and an on-board media player 219. In some embodiments, the circuitry housing 210 includes a microphone 236c.

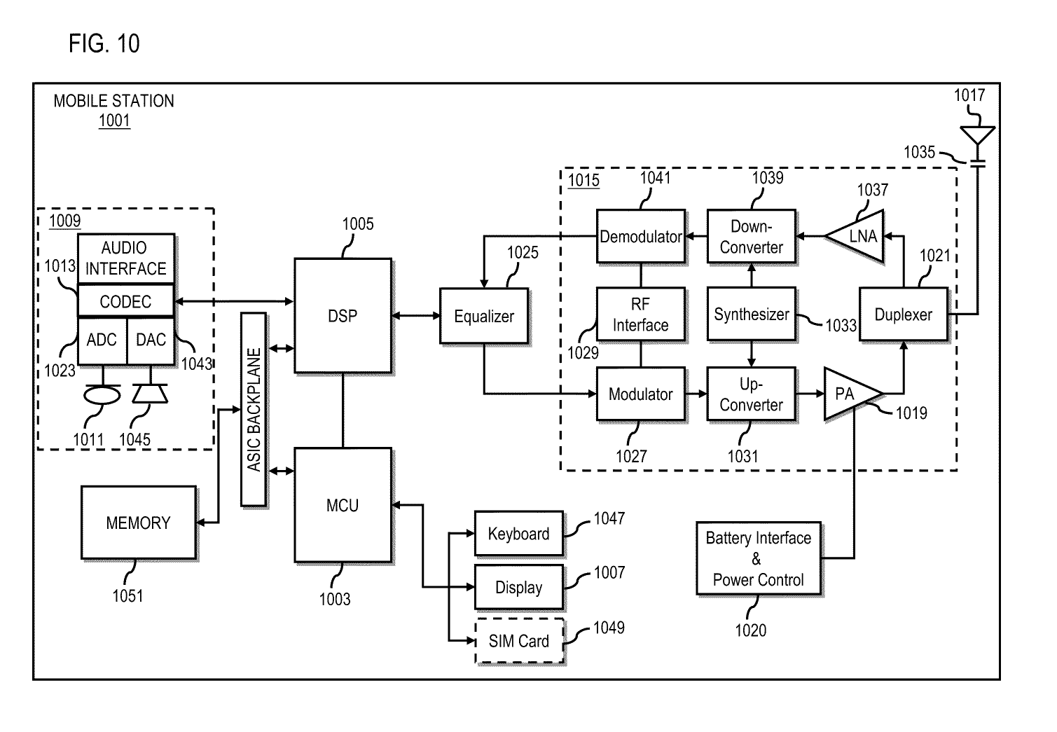

The wireless transceiver 212 is any combined electromagnetic (em) wave transmitter and receiver known in the art that can be used to communicate with a network, such as network 105. An example transceiver includes multiple components of the mobile terminal depicted in FIG. 10 and described in more detail below with reference to that figure. In some embodiments, the audio interface unit 160 is passive when in wireless mode, and only a wireless receive, e.g., an FM receiver, is included.

In some embodiments, wireless transceiver 212 is a full cellular engine as used to communicate with cellular base stations miles away. In some embodiments, wireless transceiver 212 is a WLAN interface for communicating with a network access point (e.g., “hot spot”) hundreds of feet away. In some embodiments, wireless transceiver 212 is a WPAN interface for communicating with a network device, such as a cell phone or laptop computer, with a relatively short distance (e.g., a few feet away). In some embodiments, the wireless transceiver 212 includes multiple transceivers, such as several of those transceivers described above.

In the illustrated embodiment, the audio interface unit includes several components for providing audio content to be played in earbuds 220, including radio receiver 214, on-board media player 219, and audio input cable 244. The radio receiver 214 provides audio content from broadcast radio or television or police band or other bands, alone or in some combination. On-board media player 219, such as a player for data formatted according to Moving Picture Experts Group Audio Layer 3 (MP3), provides audio from data files stored in memory (such as memory 905 on chipset 900 described below with reference to FIG. 9). These data files may be acquired from a remote source through a WPAN or WLAN or cellular interface in wireless transceiver 212. Audio input cable 244 includes audio jack 242 that can be connected to a local audio source, such as a separate local MP3 player. In such embodiments, the audio interface unit 200 is essentially a multi-functional headset for listening to the local audio source along with other functions. In some embodiments, the audio input cable 244 is omitted. In some embodiments, the circuitry housing 210 includes a female jack 245 into which is plugged a separate audio output device, such as a set of one or more speakers in the user's home or car or other facility.

In the illustrated embodiment, the circuitry housing 210 includes a text-audio processor 216 for converting text to audio (speech) or audio to text or both. Thus content delivered as text, such as via wireless transceiver 212, can be converted to audio for playing through earbuds 220. Similarly, the user's spoken words received from one or more microphones 236a, 236b, 236c (collectively referenced hereinafter as microphones 236) can be converted to text for transmission through wireless transceiver 212 to a network service. In some embodiments, the text-audio processor 216 is omitted and text-audio conversion is performed at a remote device and only audio data is exchanged through wireless transceiver 212 or radio receiver 214. In some embodiments, the text-audio processor 216 is simplified for converting only a few key commands from speech to text or text to speech or both. By using a limited set of key commands of distinctly different sounds, a simple text-audio processor 216 can perform quickly with few errors and little power consumption.

In the illustrated embodiment, the circuitry housing 210 includes an audio mixer module 218, implemented in hardware or software, for directing audio from one or more sources to one or more earbuds 220. For example, in some embodiments, left and right stereo content are delivered to different earbuds when both are determined to be in the user's ears. However, if only one earbud is in an ear of the user, both left and right stereo content are delivered to the one earbud that is in the user's ear. Similarly, in some embodiments, when audio data is received through wireless transceiver 212 while local content is being played, the audio mixer module 218 causes the local content to be interrupted and the audio data from the wireless transceiver to be played instead. In some embodiments, if both earbuds are in place in the user's ears, the local content is mixed into one earbud and the audio data from the wireless transceiver 212 is output to the other earbud. In some embodiments, the selection to interrupt or mix the audio sources is based on spoken words of the user or preferences set when the audio interface unit is configured, as described in more detail below.

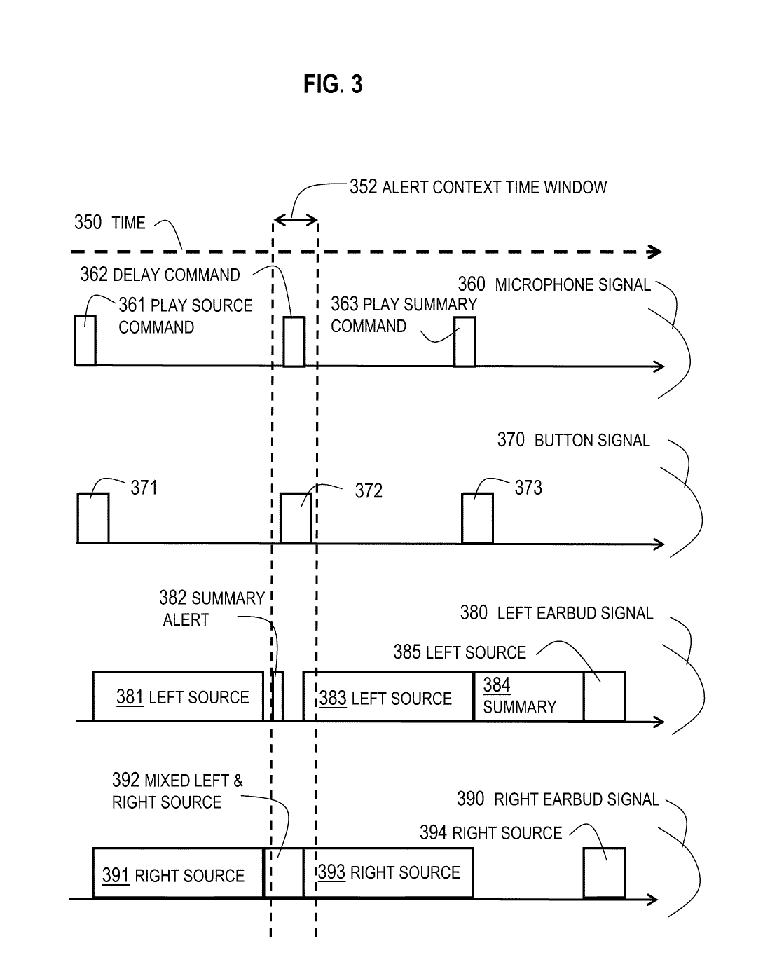

FIG. 3 is a time sequence diagram that illustrates example input and audio output signals at an audio interface unit, according to an embodiment. Specifically, FIG. 3 represents an example user experience for a user of the audio interface unit 160. Time increases to the right for an example time interval as indicated by dashed arrow 350. Contemporaneous signals at various components of the audio interface unit are displaced vertically and represented on four time lines depicted as four corresponding solid arrows below arrow 350. An asserted signal is represented by a rectangle above the corresponding time line; the position and length of the rectangle indicates the time and duration, respectively, of an asserted signal. Depicted are microphone signal 360, activation button signal 370, left earbud signal 380, and right earbud signal 390.

For purposes of illustration, it is assumed that the microphone is activated by depressing the activation button 232 while the unit is to process the incoming sounds; and the activation button is released when sounds picked up by the microphone are not to be processed. It is further assumed for purposes of illustration that both earbuds are in place in the corresponding ears of the user. It is further assumed for purposes of illustration that the user had previously subscribed, using browser 109 on UE 101 to interact with the personal audio service 143, for audio summary of activity for a user to the audio interface unit 160.

At the beginning of the interval, the microphone is activated as indicated by the button signal portion 371, and the user speaks a command picked up as microphone signal portion 361 that indicates to play an audio source, e.g., “play FM radio,” or “play local source,” or “play stored track X” (where X is a number or name identifier for the local audio file of interest), or “play internet newsfeed.” For purposes of illustration, it is assumed that the user has asked to play a stereo source, such as stored track X.

In response to the spoken command in microphone signal 361, the audio interface unit 160 outputs the stereo source to the two earbuds as left earbud signal 381 and right earbud signal 391 that cause left and right earbuds to play left source and right source, respectively. At about the same time the action of rendering track X is reported to the activity summary service 170.

When a notification event occurs (e.g., a scheduled summary is available for delivery from the activity summary service 170) for the user, an alert sound is issued at the audio interface unit 160, e.g., as left earbud signal portion 382 indicating a summary delivery alert. For example, in various embodiments, the activity summary service 170 determines that a scheduled time for delivery of the daily summary has arrived and encodes an alert sound in one or more data packets and sends the data packets to personal audio client 161 through wireless link 107a or indirectly through personal audio agent 145 over wireless link 107b. The client 161 causes the alert to be mixed in to the left or right earbud signals, or both. In some embodiments, personal audio service 143 just sends data indicating a scheduled summary; and the personal audio client 161 causes the audio interface unit 160 to generate the alert sound internally as summary alert signal portion 382. In some embodiments, the stereo source is interrupted by the audio mixer module 218 so that the alert signal portion 382 can be easily noticed by the user. In the illustrated embodiment, the audio mixer module 218 is configured to mix the left and right source and continue to present them in the right earbud as right earbud signal portion 392, while the call alert signal in left earbud signal portion 382 is presented alone to the left earbud. This way, the user's enjoyment of the stereo source is less interrupted, in case the user prefers the source over the summary alert.

The summary alert left ear signal portion 382 initiates an alert context time window of opportunity indicated by time interval 352 in which microphone signals (or activation button signals or motion sensor data) are interpreted in the context of the alert. Only sounds or gestures that are associated with actions appropriate for responding to a call alert are tested, e.g., only “play,” “ignore,” “delay” are tested by the audio-text processor 216 or the remote personal audio service 143. Having this limited context-sensitive vocabulary greatly simplifies the processing, thus reducing computational resource demands on the audio interface unit 200 or remote host 140, or both, and reducing error rates. In some embodiments, the activation button signal can be used, without the microphone signal, to represent one of the responses, indicated for example by the number or duration of depressions of the button, or by timing a depression during or shortly after a prompt is presented as voice in the earbuds). In some of these embodiments, no speech input is required to use the audio interface unit.

In the illustrated embodiment, the user responds by activating the microphone as indicated by activation button signal portion 372 and speaks a command to delay the summary, represented as microphone signal portion 362 indicating a delay command. As a result, the summary audio stream is not put through to the audio interface unit 160. As a result of the delay command, the response to the summary alert is concluded and the left and right sources for the stereo source are returned to the corresponding earbuds, as left earbud signal portion 383 and right earbud signal portion 393, respectively.

At a later time, the user decides to listen to the activity summary. The user activates the microphone as indicated by activation button signal portion 373 and speaks a command to play the activity summary audio stream, represented as microphone signal portion 363 indicating a play activity summary command. As a result, the audio stream for the user's activity summary is forwarded to the audio interface unit 160. In some embodiments, the speech recognition engine (e.g., text-audio processor 216) interprets the microphone signal portion 363 as the play summary command and sends a message to the personal audio service 143 to provide the activity summary audio stream. In other embodiments, the microphone signal portion 363 is simply encoded as data, placed in one or more data packets, and forwarded to the personal audio service 143 that does the interpretation.

In either case, the audio stream of the activity summary is received from the activity summary service 170 through the personal audio service 143 at the personal audio client 161 as data packets of encoded audio data, as a result of the microphone signal portion 363 indicating the play activity summary command spoken by the user. The audio mixer module 218 causes the audio represented by the audio data to be presented in one or more earbuds. In some embodiments, the activity summary is in stereo and left and right activity signals are presented at left and right earbuds, respectively. In the illustrated embodiment, the activity summary audio stream is presented as left earbud signal portion 384 indicating the activity summary audio stream and the right earbud signal is interrupted. In some embodiments, the stereo source is paused (i.e., time shifted) until the activity summary audio stream is completely rendered. In some embodiments, the stereo source that would have been played in this interval is simply lost.

When the activity summary audio stream is complete, the audio mixer module 218 restarts the left and right sources of the stereo source as left earbud signal portion 385 and right earbud signal portion 394, respectively.

Although shown as an audio alert above, in other embodiments based on pre-set preferences described below, the summary playback starts automatically, without an alert. In some embodiments, other alerts are used on other devices. For example, a visual clue becomes visible in a graphical user interface (GUI) of a different device, or the user initiates retrieval of the summary, or the content arrives in an email with specific subject and a programs starts automatically that converts to audio and allows the user to know that the summary is now available.

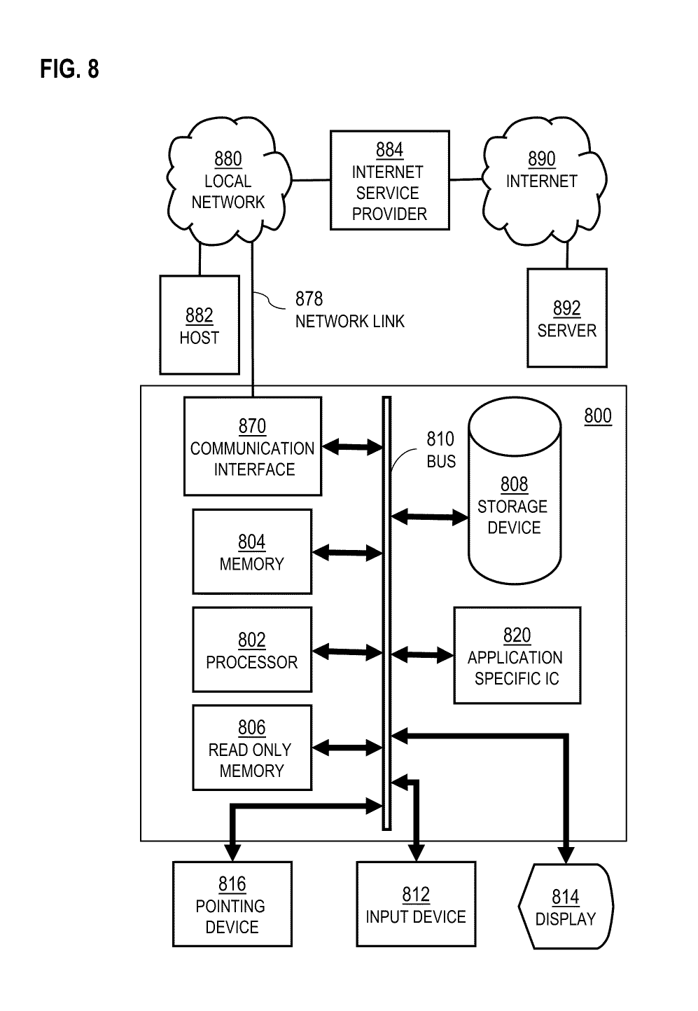

In some embodiments, the audio interface unit includes a data communications bus, such as bus 901 of chipset 900 as depicted in FIG. 9, and a processor, such as processor 903 in chipset 900, or other logic encoded in tangible media as described with reference to FIG. 8. The tangible media is configured either in hardware or with software instructions in memory, such as memory 905 on chipset 900, to determine, based on spoken sounds of a user of the apparatus received at a microphone in communication with the tangible media through the data communications bus, whether to present audio data received from a different apparatus. The processor is also configured to initiate presentation of the received audio data at a speaker in communication with the tangible media through the data communications bus, if it is determined to present the received audio data.

FIG. 4 is a diagram of components of a personal audio service module 430, according to an embodiment. The module 430 is an embodiment of personal audio service 170 and includes a web user interface 435, a time-based input module 432, an event cache 434, an organization module 436, and a delivery module 438. The personal audio service module 430 interacts with the personal audio client 161, a web browser (such as browser 109), and network services 439 (such as social network service 133) on the same or different hosts connected to network 105.

The web user interface module 435 interacts with the web browser (e.g., browser 109) to allow the user to specify what content and notifications (also called alerts herein) to present through the personal audio client as output of a speaker (e.g., one or more earbuds 220) and under what conditions, including a configure summary module 471 of the activity summary service. Thus web user interface 435 facilitates access to, including granting access rights for, a user interface configured to provide an activity summary service. Details about the functions provided by configure summary module 471 are more fully described below with reference to FIG. 6A, FIG. 6B and FIG. 6C. In brief, the configure summary module 471 of the web user interface module 435 is a web accessible component of the personal audio service where the user can indicate the duration of the audio stream, or the period of time over which activities are to be summarized, or the network sources of activity, or the persons of interest whose activity is to be summarized, or the delivery schedule or condition, or the celebrity or other voice to use in the conversion from text to speech, or the priorities for including various actions in the summary, or some combination.

The time-based input module 432, acquires the content used to populate one or more channels defined by the user, including the activities summary data stream. Sources of content or activities for presentation include one or more of voice calls, short message service (SMS) text messages (including Twitter™), instant messaging (IM) text messages, electronic mail text messages, Really Simple Syndication (RSS) feeds, status or other communications of different users who are associated with the user in a social network service (such as social networks that indicate what a friend associated with the user is doing and where a friend is located), broadcast programs, world wide web pages on the internet, streaming media, music, television broadcasting, radio broadcasting, games, or other content, or other applications shared across a network, including any news, radio, communications, calendar events, transportation (e.g., traffic advisory, next scheduled bus), television show, and sports score update, and messages from one or more activity summary clients, such as activity summary client 173 on personal audio client 151 or UE 101, among others. This content is acquired by one or more modules included in the time-based input module such as an RSS aggregator module 432a, an application programming interface (API) module 432b for one or more network applications, and an activity aggregator module 473.

The RSS aggregation module 432a regularly collects any kind of time based content, e.g., email, twitter, speaking clock, news, calendar, traffic, calls, SMS, radio schedules, radio broadcasts, in addition to anything that can be encoded in RSS feeds. A received calls module (not shown) enables cellular communications, such as voice and data following the GSM/3G protocol to be exchanged with the audio interface unit through the personal audio client 161. In the illustrated embodiment, the time-based input module 432 also includes a activity aggregator 473 and a received sounds module 432c for sounds detected at a microphone 236 on an audio interface unit 160 and passed to the personal audio service module 430 by the personal audio client 161.

The activity aggregator module 473 monitors communications with UE 101 and audio interface unit, determines the user, time, application, text, or other person, if any, associated with the communication, or some combination and marks that information for storage in activity database 475. The functions of activity aggregator module 473 are described in more detail below with reference to FIG. 6B. The activity aggregator module 473 also receives messages from zero or more activity summary clients on one or more devices operated by a user, e.g., activity summary client 173 in personal audio client 161 Recall that activity includes presence status information, context information, or physical activities like walking, sitting, driving, etc. or even social activities like attending a meeting, having a discussion, engaging in a business lunch, etc. any sources may be used, such as motion sensors, audio sniffing, calendar item information.

In some embodiments, the aggregator obtains data about celebrities or sports stars. For example, if the friends are fans of different players on different teams in a sport, activity data may be available from network sites of those teams. For example, in hockey, each fan's hockey players' points, wins and losses can be compared in the summary. Thus, data is aggregated indicating that Chicago hockey player No. 15 scored the previous night twice and the team won by 2-0 and, Maple Leafs' player No. 9 did not score but had two small penalties and the team lost the game by 3-4. This kind of activity can be obtained in web pages and can be added to this activity database. The hockey league may provide this as premium service for the fans. This may include how the team had concentrated on the game before the game, including travelling, and how the team performed in the game. In another embodiment, the Maple Leaf's fan who watched the game celebrates with his favorite team and highlights of that fan's celebration will be part of the database for consideration when the summary is formed. Activity and undertakings of different fans are collected and one or more summaries can be shared among fans who are friends.

Some of the time-based input is classified as a time-sensitive alert or notification that allows the user to respond optionally, e.g., a notification of an incoming voice call that the user can choose to take immediately or bounce to a voicemail service.

The event cache 434 stores the received content temporarily for a time that is appropriate to the particular content by default or based on user input to the web user interface module 435 or some combination. For example, data about one or more actions of interest to a user is stored in activity database 475. Some events associated with received content, such as time and type and name of content, or data flagged by a user, are stored permanently in an event log by the event cache module 434, either by default or based on user input to the web user interface module 435, or time-based input by the user through received sounds module 432c, or some combination. In some embodiments, the event log is searchable, with or without a permanent index. In some embodiments, temporarily cached content is also searchable. Searching is performed in response to a verbal command from the user delivered through received sounds module 432c, or specified by other input from the user, or combination.

The organization module 436 filters and prioritizes and schedules delivery of the content and alerts based on defaults or values provided by the user through the web user interface 435, or some combination. The organization module 436 uses rules-based processing to filter and prioritize content, e.g., don't interrupt user with any news content between 8 AM and 10 AM, or block calls from a particular number. The organization module 436 decides the relative importance of content and when to deliver it. If there are multiple instances of the same kind of content, e.g., 15 emails, then these are grouped together and delivered appropriately. The organized content is passed onto the delivery module 438.

In the illustrated embodiment, the organization module 436 includes the summarize module 477 that summarizes data associated with a user in the activity database 475 within a particular period of time. The functions of summarize module are described in more detail below with reference to FIG. 6C. As described in FIG. 6C, priority of different actions are determined based on context, such as time and place of action, persons involved, or semantics of communications or content rendered on a user or user friend device, or prioritized based on user preferences indicated though configure summary module 471, or both. Content associated with each prioritized action is identified for conversion to audio. Appropriate audio background sounds and links are also determined by summarize module 477 in some embodiments. For example, knowing positions by a global positioning system (GPS) receiver and the physical activity that the user was driving or flying, a sound of a car or a plane, respectively, can be inserted. In some embodiments, some typical or characteristic music that is somehow related to the person, the vehicle or the destination can be played. After inserting this music a link is inserted, e.g., a link to the OVI™ Music Store of Nokia Inc. of Finland.

The delivery module 438 takes data provided by organization module 436 and optimizes it for difference devices and services. In the illustrated embodiment, the delivery module 438 includes a voice to text module 498a, an API 438b for external network applications, a text to voice module 438c, and a cellular delivery module 438d. API module 438b delivers some content or sounds received in module 432c to an application program or server or client somewhere on the network, as encoded audio or text in data packets exchanged using any known network protocol. For example, in some embodiments, the API module 438b is configured to deliver text or audio or both to a web browser, as indicated by the dotted arrow to browser 109. In some embodiments, the API delivers an icon to be presented in a different network application, e.g., a social network application; and, module 438b responds to selection of the icon with or to one or more choices to deliver audio from the user's audio channel or to deliver text, such as transcribed voice or the user's recorded log of channel events. For some applications or clients voice content or microphone sounds received in module 432c are first converted to text in the voice to text module 438a. The voice to text module 438a also provides additional services like: call transcriptions, voice mail transcriptions, reminders, and note to self, among others. Cellular delivery module 438d delivers some content or sounds received in module 432c to a cellular terminal, as audio using a cellular telephone protocol, such as GSM/3G. For some applications, text content is first converted to voice in the text to voice module 438c, e.g., for delivery to the audio interface unit 160 through the personal audio client 161.

In some embodiments, the activity summary service module 170 comprises configure summary module 471, activity aggregator module 473, activity database 475 and summarize module 477.

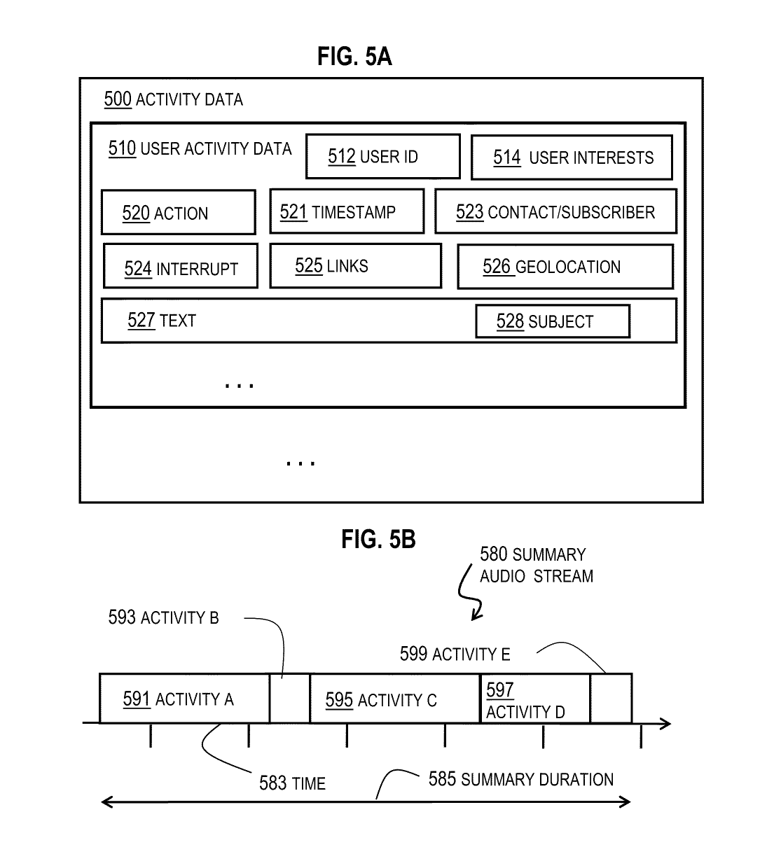

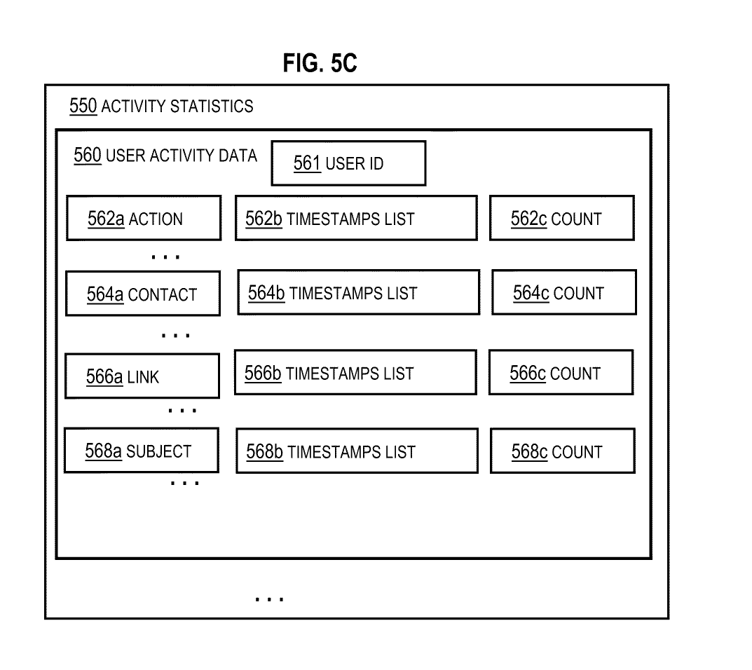

FIG. 5A is a diagram that illustrates activity data 500 in a message or storage data structure, according to an embodiment. For example, activity data 500 is a storage data structure of the activity database 473 depicted in FIG. 4. Although activity data 500 is depicted as integral fields in a particular order in one message or data structure for purposes of illustration, in other embodiments one or more fields or portions thereof are arranged in a different order in one or more data structures or message, or one or more fields or portions thereof are omitted, or one or more fields are added, or the activity data is changed in some combination of ways.

In the illustrated embodiment, activity data 500 includes user activity data record 510 for each of one or more users. Activity data records for one or more additional users are indicated by ellipsis below record 510. Each user activity data record 510 includes for one user (or a group of users) a user/group identifier (ID) field 512 and a user interests field 514. For each action associated with the user, the record 510 includes an action field 520, a timestamp field 521, a contact/subscriber field 523, an interrupt field 524, a links field 525, a geolocation field 526 and a text field 527, which are repeated for each action that is tracked for the user, as indicated by ellipsis below text field 527.

The user ID field 512 holds data that indicates a particular user or group of users who share a summary, such as the group of hockey fans. For example, in some embodiments, the data in field 512 indicates a user profiles data structure 137 with one or more other identifiers, such as an email address, social networking name, actual name, a name associated with a cell phone number or other account on other services.

The user interests field 514 holds data that indicates one or more values for one or more context parameters, which are of priority to a user (or group of users). In some embodiments, priority of a value for a context parameter is itself a parameter capable of assuming one of multiple values, such as 1 for a highest level of priority, 2 for a secondary level of priority, etc., to a maximum value for a lowest specified level of priority. Parameter values not associated with one of the priority values is equivalent to no priority, lower than the lowest specified level. For example, in some embodiments data in user interests field 514 indicates a high priority is associated with one or more members in the contact book 139 associated with the user profile data structure of the user identified in field 512. In other embodiments, data in user interests field 514 indicates a high priority is associated with one or more subjects, such as “family” or “science” or “music.” In some embodiments, a user can express a preference for activities either most similar to or most different from the user's own current activities. For example, those friends that have similar activities as the user's activities, can be selected as most relevant ones; but the user can also indicate that very opposite types are high priority for the summary. Thus, if the user worked hard all day, this preference determines whether to listen to the activities of someone else who did the same or someone who had a totally different activity, e.g. going for a holiday.

The action field 520 holds data that indicates an action associated with a network source specified by the user identified in field 512, such as an application executed on a user device, a network service initiated, content rendered, a communication sent or received by the user (e.g., cell phone call, email, instant message, tweet), a posting sent by the user to a social networking service, a physical movement of the user (e.g., motion detected by motion sensor 108 or 238 or a text description deduced from the motion, such as “driving”, “walking,” “running,” “jumping,” “tennis,” among others, using any method known in the art), or an application or network service or content rendered or communication sent or received or posting or physical movement by another subscriber associated with the user in a social network.

The timestamp field 521 holds data that indicates a time when the action 520 occurred, such as a time that an email was delivered or received, or a start time and end time associated with rendering content, or the time that a posting was made by a contact of the user.

The contact/subscriber field 523 holds data that indicates one or more contacts of the user, e.g., for instant messaging or emails, or one or more subscribers different from the user for the social network service or other network service, or one or more celebrities of interest to the user such as a band, an actor, a sports figure or a politician. The contact/subscriber field 523 is used, for example, to indicate one or more contacts to whom an email is addressed or from whom an email is received, or a friend of the user who posted a status update to a social network service or viewed or commented on a posting by the user. Or a favorite players whose actions are being tracked.

The interrupt field 524 holds data that indicates whether the action indicated in field 520 was interrupted before completion, e.g., a user closed or powered down a device before reading to the end of a current web page, or closed a document before scanning to the end of the document. In some embodiments, the interrupt field 524 includes data that indicates what portion of the action was completed before the interruption, and on what device. It can be imagined that the user wants to continue the action and the processing of the content on another device and in this case the interrupt field can help to identify where to continue the browsing of the content. For example, an interrupt is recorded when a user is reading a web page in the office on the laptop and then gets a call to get home earlier today, powering down the laptop and leaving the office. The user may wish to continue the very same content in the car via an audio channel from his mobile device.

The links field 525 holds data that indicates one or more links associated with the action, such as a uniform resources locator (URL) address for a web service or content indicated in action field 520.

The geolocation field 526 holds data that indicates a geolocation associated with the action, such as a geolocation of a subscriber whom made a posting to the social networking service or of the user when the user performed and action. In some embodiments, relevance of an action is learned or based in part on geolocation.

The text field 527 holds data that indicates text associated with the action, such as contents of an email or status report. Any method may be used to associate text with the action, such as text in a subject line or body of an email or other message sent during the action, or in a document open at the time the action was performed, or in metadata associated with content rendering that is indicated in action field 520, such as lyrics or artist name for a song being played. In some embodiments, the text field includes a subject field 528 that indicates a subject or topic of the text in the rest of the field, for example, the subject line of an email or title of a song being played. In some embodiments, the subject is derived by a semantics engine from the text in the text field. Any semantics engine known in the art may be used, such as a semantics engine of the APACHE LUCENE open source search engine from The Apache Software Foundation incorporated in Delaware. A topic is often deduced from the most frequently used keywords in a sample of text, where keywords are unusual words that distinguish samples of text from each other. In some embodiments, the summary of the action is based on the subject text in field 528 and not the full text in field 527. In some embodiments, the summary is based on data in one or more of the other fields, such as a name for the action, or a name of a contact, or some combination. For example, a summary might comprise the words “played track X by artist Y.”

FIG. 5B is a time sequence diagram that illustrates activity summary audio stream 580, according to an embodiment. Time is indicated by horizontal axis 583. The duration 585 of the audio stream that summarizes activity is divided into multiple portions. A portion 591 includes audio data indicating activity A. Similarly, portion 593 includes audio data indicating activity B; portion 595 includes audio data indicating activity C, portion 597 includes audio data indicating activity D; and portion 599 includes audio data indicating activity E. In some embodiments, only the most relevant activities that fit in the summary duration 585 are included in the audio stream 580. In some embodiments, the duration is expanded or contracted to fit the some or all activities to a preset level of relevance. The audio data in each potion includes speech derived from text based on the activity data for the corresponding action. In some embodiments, the speech is formed so as to sound like a particular person or celebrity of choice. In some embodiments, the audio data in a potion includes background sounds associated with the activity, such as ocean wave sounds associated with a social network posting from a contact that indicates travel to a sea shore. In some embodiments, the audio data in a portion includes an alert sound or audio icon indicating a link is available for the activity—such as a link to a hotel at the sea side resort indicated by the contact's posting. In some embodiments, the link alert actually comprises audio data that describes the link, e.g., to the hotel or to the background music or the name of the URL address. User input upon hearing the link alert determines whether the link is ignored, stored for later use (bookmarked) or followed to bring up related content—either on the audio interface unit or some other user equipment. In some embodiments, each audio portion is associated with a link on the activity summary service 170; and a link alert is not used.

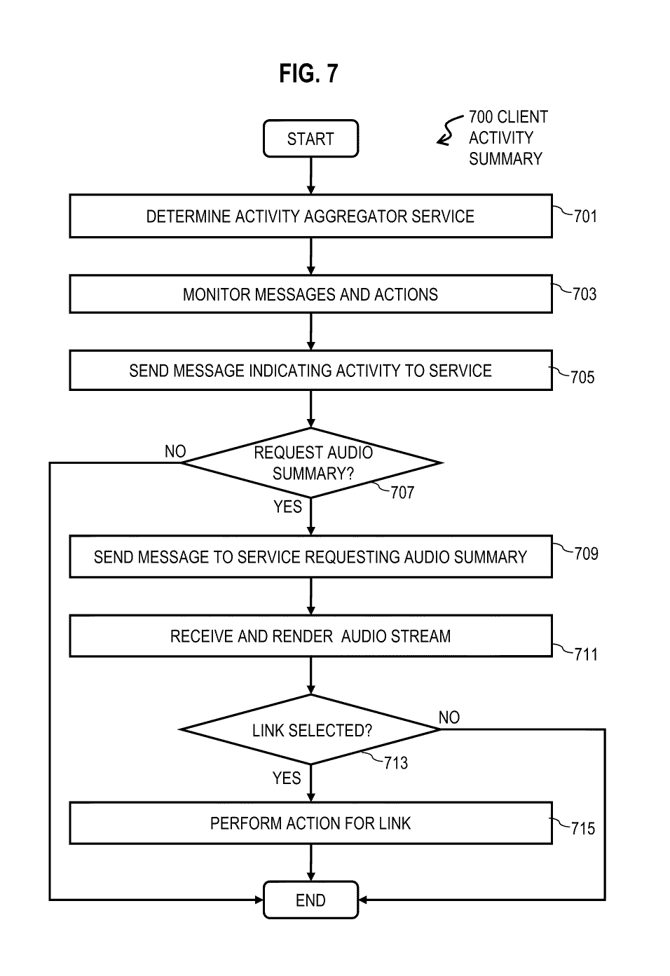

FIG. 6A is a flowchart of a server process for providing an audio summary of activity for a user, according to one embodiment. In one embodiment, the activity summary service 170 performs the process 600 and is implemented in, for instance, a chip set including a processor and a memory as shown FIG. 9, or computer system as shown in FIG. 8. Although steps are shown in FIG. 6A and other flowcharts FIG. 6B. FIG. 6C and FIG. 7, in a particular order for purposes of illustration, in other embodiments, one or more steps, or portions thereof, are performed in a different order or overlapping in time, in series or parallel, or one or more steps are omitted, or other steps are added, or the method is changed in some combination of ways.

In step 601, activity summary configuration data is determined. The activity summary configuration data indicates the activities to track for a particular user. For example, the configuration data indicates one or more network sources on which activity is to be tracked, or one or more devices that belong to a particular user, the duration of the audio stream, or the period of time over which activities are to be summarized, or the people to track, or the delivery schedule or condition, or the celebrity voice to use in the conversion from text to speech, or the priorities for including various actions in the summary, such as the priorities to be associated with particular contacts of the user, or the social websites and usernames and passwords to check for activity, or some combination. Any method may be used to determine this data. For example, in some embodiments, the data is received by way of user interaction with web server interface 435. In other embodiments, the data is included as a default value in software instructions, is received as manual input from a network administrator or user on the local or a remote node, is retrieved from a local file or database, or is sent from a different node on the network, either in response to a query or unsolicited, or the data is received using some combination of these methods.

In some embodiments, step 601 includes installing an activity summary client module 173 on one or more of the user devices determined during step 601.

For purposes of illustration it is assumed that a user provides configuration data to indicate that activities should be summarized over a particular time period of one day, and delivered in a summary of certain duration, for example two minutes, automatically at a certain time, such as 9 PM, every day to the user's audio interface unit, and to give higher priority to the posts of friends on one or more social network pages, medium priority to certain blogs and updates at a certain content store webpage and lower priority to tweets and email, and to give higher priority to the activity of the user and twenty named friends and sixteen named family members. In some embodiments, different time periods, duration and delivery schedules are configured for different days of the week, weekends, holidays and vacations.

An advantage of user configuration is that the activity summary service is only asked to handle activity at a limited number of network sources, thus greatly reducing the network traffic involved compared to having multiple services send messages indicating all activity to a central service. Thus user configuration to check a limited number of network sources is an example of means to achieve this advantage.

In step 603, activity is tracked at one or more network sources associated with a user; and the activity is stored in an activities database. For example, activity data 500 is obtained in one or more messages received or originated at the personal audio host 140 and stored in activity database 475. In some embodiments, all network communications from one or more user devices are channeled through a gateway server, such as personal audio service 143, and monitoring these messages is sufficient to track activity at the user devices. In some embodiments, messages with activity data, such as activity data 500, are received from one or more activity summary client modules 173 on UE 101 or audio interface unit 160. In some embodiments, the personal audio host queries one or more network services identified by the user for activity of interest to the user. More detail on step 603 is provided below with reference to FIG. 6B. Thus, in some embodiments, tracking activity includes determining a time and content (such as text) associated with an action at the one or more network sources (including the one or more user devices), wherein the action is one or more of: content that is rendered, received, sent or changed; a communication with a contact; an application that is executed; a posting to a social network service by a subscriber who is associated with the user; posting of a news service or network service, or data entered by the user; or an action or activity or context of a friend or colleague or family member, etc. or any combination thereof.

It is assumed, for purposes of illustration, that it is determined that over the last twenty four hours on UE 101 twelve cell phone calls were connected with ten different contacts, that one map application was executed, and that twenty text messages were sent to four different contacts, including contact A, who also was involved in two cell phone calls, and that one game was played, and that five web pages were opened of which the last one was not closed. It is also determined that eighteen songs were played on audio interface unit 160. It is also determined that fifteen posts were viewed by the user on a home computer of the user and that four other posts were made to a social network service the activity summary service was configured to check. It is also determined that two blogs of interest (e.g., that the activity summary service was configured to check) were updated.

In step 605, an audio stream is generated that summarizes the activity over a particular time period. More detail on step 603 for some embodiments is provided below with reference to FIG. 6C. In one embodiment, duration of a complete rendering of the audio stream is shorter than the particular time period over which activity is summarized. For example, a two minute audio stream is generated indicating activities for a time period of 24 hours or more. An advantage of a short duration summary is that less bandwidth is needed at the network links from the summary service to the particular user device where the audio stream is delivered. Furthermore, less memory is needed on the particular device. In additions, less processor time is needed to render the summary, and the user more readily has time to listen to the summary. Thus, a short duration audio stream, for example of duration less than about five minutes, which summarizes activities over a longer time period such as about one day, is an example of one means to achieve this advantage.

In some embodiments, the activities are ordered from highest to lowest priority. As an example of summarizing by priority based on relevance, the two minute audio stream includes audio describing ten of the fifteen posts viewed by the user on the home computer and three of the four other posts from the configured group of twenty friends and 16 family members followed by a post from contact A, deemed important because of the frequency of the communications between the user and contact A over the past week. The audio stream includes, after the posts, audio data describing the web page interrupted, followed by audio data describing the score of the games played, followed by audio data describing the most important tweets received. It is assumed, for purposes of illustration, that the remaining activities of lower priority were not presented because they would have exceeded the two minute duration limit set during configuration step 601. Thus, in some embodiments, step 605 includes determining relevance for at least one of each activity or each portion of text associated with an activity; and, generating the audio stream based only on at least one of a most relevant activity or a most relevant portion of text of the most relevant activity. However, the user can reach always beyond the 2 minutes limit as the original data the summary is made from is always available via an associated link; and thus the user can jump into the “raw”, unfiltered data. In some embodiments, the duration of the summary audio stream is determined based on the total amount of activity and/or content. Further, the high priority activities and/or content may be given more time than the low priority activities and/or content. In some further embodiments, the user may extend the duration of the summary audio stream or any item of the summary while rendering the summary by giving a user input indicating to extend the duration. Other configuration changes can be performed using a simple prompt and response between the system and the user when starting the summary. Such a dialog for user input affects a summary that is rendered at run-time.

The activity data is converted to audio data, at least in part, by converting text to speech, using any text to speech engine known in the art. Thus, generating the audio stream further comprises converting text determined during tracking the activity into speech. An advantage of converting text to speech is that much activity data is comprised of text, thus many of the relevant facts of the activity can be converted to audio for the audio stream by using a text to speech engine. A text to speech engine is one example means for achieving this advantage.

It is also assumed for purposes of illustration that the text converted to speech is apparently spoken by a famous actress. Thus, in some embodiments, converting text into speech further comprises converting text to a selected voice, such as a celebrity voice. An advantage of the selected or celebrity voice is that it is often as rapid to convert text to speech using any voice, and yet may be more desirable for some users, and therefore creates a greater demand for the service and makes better use of available network resources. Thus a premium service can be established based on the celebrity voice. Use of celebrity voice in text to speech conversion is one example means to achieve this advantage. In some embodiments, the selected voice is the user's voice or a voice of a non-celebrity for whom a voice sample is available.

It is also assumed, for purposes of illustration, that a beach song is played during the recitation of the post by a contact B because the subject of the post is a trip to the beach. It is also assumed, for purposes of illustration, that a link is associated with the end of the beach song to a website where the song can be bought and downloaded. Thus audio content related to a particular activity is determined; and the audio content is added as background to a summary of the particular activity. An advantage of background sounds is thus to increase the amount of information being conveyed within the duration of an audio stream. Use of background sounds is an example means to achieve this advantage.

In step 607, the audio stream is caused to be delivered to a particular device. For example, on a given schedule, an alert is sent to the audio interface unit or to an email client that the activity summary is ready to be delivered. In response to a request for the activity summary, the audio stream 580 is sent to the requesting device, whether to browser 109 on UE 101 or personal audio client 161 on audio interface unit 160 or some other device configured by the user. Because the audio interface unit 160 is a mobile device and the UE 101 is a mobile device in at least some embodiments, the particular device to which the audio summary is delivered is a mobile device in some embodiments. An advantage of a mobile device is that the user can listen to the summary wherever the user may be located and need not be at a desk with a desktop computer, wired stereo system, cable television or other fixed device. Delivering the audio content to a mobile device is an example means to achieve this advantage.

The user 190 may then render the audio stream, such as when the user 190 relaxes at the end of the day in an easy chair and closes his or her eyes to listen peacefully to the summary of the important activities of the day. The user hears the voice of the famous actress reciting the posts, including the post of contact A, the post of contact B with the beach music in the background, and reciting at least the subjects of the two blogs of interest.

In step 609, a network link to content associated with one or more portions of the summary audio stream 580 is also caused to be delivered to a particular device of the user. For example, an audio alert or audio icon is included in the audio stream at the end of the beach song to indicate a link is associated with the corresponding portion of the audio stream. In some embodiments, the link is simply sent to the user in a separate email or is inserted on a social networking page for the user, or opens the user's browser to a webpage with the links associated with the audio summary. For purposes of illustration, the link to the beach song is included in an email to the user. Thus, a link to content related to at least a portion of the audio stream is caused to be delivered. An advantage of the link is to make each portion of the audio stream actionable, so that the user not only listens to the audio stream but can use the audio stream as a component of a user interface. The delivery of associated links is one means for achieving this advantage.

In step 611, the link is caused to be acted on, based on user input received in response to causing the network link to be delivered in step 609. For example in response to an audio alert indicating the link, the user speaks a command or presses a key that indicates the link should be bookmarked, and the link is included in a home page of the user's social network. If, instead, the user speaks a command or presses a key that indicates the link should be followed immediately, then an application, such as a browser, is launched to open the resource indicated by the link. For example a music store client is opened on UE 101 that presents a graphical user interface through which the user can order or download the beach song. Thus, in some embodiments, the method includes receiving user input that indicates action on the link. An advantage of user input that indicates action on the link is to act on any or each portion of the audio stream as a component of a user interface. Receiving user input indicating action on an associated link is one means for achieving this advantage.

FIG. 6B is a flowchart of a process 620 for performing step 603 of the method of FIG. 6A, according to one embodiment. Thus process 620 is one specific embodiment of step 603.

In step 621 network services where the user is a subscriber are monitored, based on the network services identified during configuration step 601, described above, or learned based on frequency of user activities, described in more detail with reference to FIG. 6C. For example, the activity aggregator 473 logs onto a social network service every hour to update posts from all the contacts of the user (these posts are filtered for the summary in a later step, described in more detail below with reference to FIG. 6C). Similarly, the activity aggregator 473 sends a request message to the blogs and other network sources of interest, such as the hockey team sites, as identified during configuration or learned.

In step 623 messages sent to or from the user devices are monitored. The user's devices are determined based on the configuration data received from the user in step 601. In some embodiments the activity summary service is on a gateway for a user device and the messages are snooped as they are passed to and from the user device. In some embodiments, the activity aggregator 473 logs onto one or more of the user's email server and twitter accounts to monitor those messages for summarizing or for learning contacts and subjects of interest beyond those configured during step 601.

In step 625, messages are received from a user device indicating activity. For example user provides activity data in an HTTP message sent to the web user interface 435. In some embodiments, an activity summary client 173 installed on the user device sends messages indicating activity for a user. In some embodiment, activity data is based on sensor data generated on one or more user devices, such a motion sensor 108 on UE 101 or motion sensor 238 on audio interface unit 200. In some of these embodiments, user actions, such as running, swimming, skiing are deduced from the motion sensor data, using any method known in the art. In some embodiments, user actions are deduced from keystrokes recorded on the user devices, such as UE 101. In some embodiments, user activity is determined by taking short audio samples and/or using calendar information and/or proximity detection. For example, user activity is determined from Bluetooth signal detection, transactions made by device, what's the social activity of the user is, e.g. in a meeting, having lunch, in discussion. Programs working on desktop or laptop computers can also detect the user activity. All in all, by combining these different sources and intermediate classification results and pattern detection using metadata, a pretty accurate picture can be built about a user in terms of what physical and social activities are being engaged in at given moment, and even deducing the user's mental state. In some embodiments, the user device communicates with other nearby devices and can infer some level of activity information, e.g. being on a concert. In some embodiments, an activity summary client 173 is not installed on a user device; and in some such embodiments step 625 is omitted.

Steps 621, 623 and 625 together accomplish tracking activity at one or more network sources associated with a user in the illustrated embodiment. In other embodiments one or more of these steps are omitted while accomplishing the tracking of activity at one or more network sources.

In step 627, activity data is stored for the user, e.g., into activity database 475 as a user activity data record 510. For example, values are inserted for action field 520, timestamp field 521, contact/subscriber field 523, interrupt field 524, links field 525, geolocation field 536 and text field 527, as described above with reference to FIG. 5A. In some embodiments, fields associated with expired actions that have a value in timestamp field 521 that is before the particular time period of the summary, e.g., more than twenty four hours old, are deleted from the user activity data record 510 during step 627.

In step 629 statistics of usage are accumulated for various actions, persons, links, geolocations or subjects, or some combination, based on user activity. For example, for each action by the user that appears in the action field 520, such as a visit to a blog of a particular blogger, a timestamp, such as a date, is recorded in a list of timestamps. At any time a measure of the relevance of the action to the user can be derived by a weighted sum of the number of dates, where the weight for a date decreases the older the date becomes. Thus actions performed a long time ago are given little weight, while recent actions are given more weight. The weighted sum is a measure of the relevance of the action. Similar statistics are kept for each person who ever appears in the contact/subscriber field 523, each link that ever appears in the links field 525, each geolocation that ever appears in the geolocation field 526 or each subject keyword that appears in the text field 527 or subject field 528. In some embodiments a simple count is kept instead of a list of timestamps. In some of these embodiments, a timestamp of the most recent use is also kept so that actions, links, contacts, geolocations and subjects not recently used can be given less weight or deleted. Using these statistics, the activity summary service learns the actions, persons, links and subjects most relevant to the user.

FIG. 5C is a diagram that illustrates an example activity statistics data structure 550, according to one embodiment. The data structure 550 includes a user activity record 560 for each user. Other users are indicated by ellipsis below user activity record 560.

Each user activity record 560 includes a user ID field 561, similar to field 512 described above. The user activity record 560 includes a timestamps list and a count field for each action, contact, link and subject keyword occurrence associated with a user. The action field 562a, contact field 564a, link field 566a and subject field 568a, collectively referenced herein as the occurrence fields, hold data that indicates: an action, such as a visit to a blog or visit to a social network page or an email sent or email received; a contact; a link; and subject, respectively that ever appeared in a user activity record 510 for a user, at least within some recent history. In some embodiments, geolocation is included among the occurrences fields. A timestamps list field 562b, 564b, 566b, and 568b collectively referenced as timestamps list fields are associated with occurrence fields 562a, 564a, 566a, and 568a, respectively. The timestamps list fields hold data that indicates a time, such as the month, for each time associated with the occurrence. In some embodiments, the timestamps list field 562b only holds data indicating the most recent time or most recent few times of the corresponding occurrence. A count field 562c, 564c, 566c, and 568c collectively referenced as count fields are associated with occurrence fields 562a, 564a, 566a, and 568a, respectively. The count field holds data that indicates the number of times of the corresponding occurrence. In some embodiments using the timestamps list for all occurrences, the count field is omitted. Multiple other occurrences are indicated by the ellipses below occurrence fields 562a, 564a, 566a, and 568a, respectively. These statistics records may be kept private and used just to learn the user's (or group's) priorities. In other embodiments, the statistics may be shared with one or more other contacts of the user.

FIG. 6C is a flowchart of a process 640 for performing step 605 of the method of FIG. 6A, according to one embodiment. Thus process 640 is one embodiment of step 605 to generate an audio stream that summarizes the activity associated with the user.

In step 641, it is determined whether conditions are satisfied to prepare the audio stream. Any conditions may be used. For example, in some embodiments the conditions are satisfied when a user requests the audio stream. In some embodiments, the conditions are satisfied on a particular schedule, such as every day, ten minutes before the audio stream is to be delivered, e.g., at 8:50 PM for a user who wants the audio stream delivered at 9 PM. In some embodiments, the audio stream is updated regularly, e.g. every hour, so that it is ready on demand. In some embodiments, the summary audio stream is prepared immediately after a specific activity and/or content is determined. For example, it can also be set up so that the system is constantly looking for a given condition, e.g. Friend X visits a certain location, or a certain hockey player scores or is penalized, and then the system delivers an audio summary by interrupting every other process.

If conditions are satisfied to prepare the audio stream, then in step 651 the relevance of the actions stored in the data structure with the activity data 500 is determined. Relevance is based on user priorities specified during the configuration step or learned from usage statistics, e.g., statistics stored in data structure 550 depicted in FIG. 5C, and stored in user interests field 514 in some embodiments. In the illustrated embodiment, step 651 includes step 653, step 655 and step 657.

In step 653, user priorities are deduced based on the usage statistics, e.g., stored in data structure 550. For example, the most relevant persons, actions, subjects and links are determined based on the highest recent counts (e.g., weighted sums or highest counts with most recent occurrence in the last 48 hours). These high priority occurrences are added to the specified high priorities, if any, given by the user during configuration step 601. In some embodiments, priorities are not learned and step 653 is omitted.

In step 655, the actions in the time period to summarize, e.g., the last twenty four hours, are ranked by relevance. For example, a total relevance is computed for each action based on a weighted sum of the (weighted or un-weighted) counts for the action, the contact (if any), the links, the geolocation and the subject added to the configured priorities, if any. The actions are then ranked in order from most relevant to least relevant. In step 657, a high rank is given to interrupted actions. For example, the relevance of an interrupted item is increased by 50%; and its position in the rankings is adjusted accordingly.

In step 661 it is determined whether time remains in the duration of the audio stream. At first, the audio stream is empty and time remains. The duration is a configured item, with a default value, e.g., two minutes. At each subsequent return to step 661 the duration remaining is reduced by the time of an audio portion added to the stream. For purposes of illustration, it is assumed that the maximum stream duration is 2 minutes and new portions can be added that do not cause the total stream duration to exceed 2 minutes. If it is determined in step 661 that the duration of the audio stream is at the maximum, then the process ends (and control passes to step 607 to cause the audio stream to be delivered as described above with reference to FIG. 6A). In some embodiments, the user input determines whether to extend or shorten the duration.

If, in step 661, it is determined that time remains in the duration of the audio stream, then, in step 663 it is determined if there is another action in the time period to be summarized that has not yet been added to the audio stream. If not, then the audio stream is complete and the process ends. If so, then steps 671 through 679 are performed.

In step 671, the highest priority action of the remaining actions is selected, e.g., an action for a member of the user's inner circle. In step 673, text is converted to audio using a voice of a celebrity or other member, if any, indicated during configuration, to produce a current portion of the audio stream. Any text may be included. For example the data in the action field 520, the contact field 523 and the text field 527 is used to produce text that is converted to speech using any text to speech process known in the art. By having several templates that can be filled up with real data, text is easily generated from content. For example, based on GPS content, “USER_{—}1 drove 6 HOURS from LOCATION A to LOCATION B, stopped only ONCE because the WEATHER WAS RAINY. ON the trip he listened to THIS MUSIC. For example text stating “Blog X was updated by Bob with comments on Album Y from Band Z” is generated from the activity data 500. Similarly, text stating “Contact B posted to social network S pictures from Beach Resort T.” Some of these text to speech processes allow the speech to emulate the audible characteristics of any person's voice for which an adequate sample is available, including voices of celebrities. High quality text-to-speech engines are commercially available for devices, including an engine from Nokia. The type of technology used for this synthesis enables personalization using the parameters of any given person's voice. The current portion of the audio stream is timed to determine the portion of the total duration it consumes. In some embodiments, the current audio portions is slowed down or sped up to fit in the remaining time of the maximum allowed audio stream duration. In some embodiments, the user input determines whether to stretch or squeeze activities into the duration of the audio stream.

In step 675, audio content related to the action or text is determined. For example, music from Album Y or Band Z is determined for the blog activity; or breaking wave sounds are determined for the social network posting. In step 677, the speech describing the action is combined with an audio clip of the same temporal length from the content determined in step 675. Thus music from Band Z is played in the background while the celebrity voice recites “Blog X was updated by Bob with comments on Album Y from Band Z.” Similarly, breaking wave sounds are played in the background while the celebrity voice recites “Contact B posted to social network S pictures from Beach Resort T.” In some embodiments, background audio content is not combined; and, step 675 and step 677 are omitted.

In step 679 one or more links associated with the current portion of the audio stream is determined. For example, a link to Blog X and a link to a website where the user can order or download the background music are associated with the blog portion of the audio stream. Similarly, a link to a page of Contact B on the social network S is associated with the social network posting portion of the audio stream. Control passes back to step 661 to determine if time remains in the allowed audio stream duration to add another portion.

FIG. 7 is a flowchart of an optional client process 700 for providing an audio summary of activity for a user, according to one embodiment. In one embodiment, the activity summary client 173 performs the process 700 and is implemented in, for instance, a chip set including a processor and a memory as shown FIG. 9, or computer system as shown in FIG. 8. In some embodiments, some steps are omitted so that a standard client can be used to receive and render the audio stream that summarizes activities for a user.

In step 701 the activity aggregator service is determined. For example, data is received that indicates the activity summary service 170 or the activity aggregator 473 of the personal audio service 430, using any of the methods described above for receiving data.

In step 703, messages received on the device of the client process are monitored. For example, messages exchanged with UE 101 are monitored, or messages exchanged with audio interface unit 160 are monitored. From each message, an application on the user device that sends or receives the message (email, tweet, cell phone) is recorded and inserted in an action field 520 of an activity data message with user activity data 510 to be sent to the activity aggregator. Similarly, a time of the message is inserted in field 521, the other contact, if any, is inserted in field 523, data indicating whether reading of the message by the user is interrupted is inserted in field 524, geolocation is inserted into field 526 and text of the message is inserted into field 527, with a message subject, if any, inserted into field 528.

During step 703, actions are also monitored and data indicting the actions are inserted into appropriate user activity data 510 fields of an activity data message to be sent to the activity aggregator. For example, links to web pages opened with the user's browser are monitored, as are games played, movements made, and actions associated with such movements, such as walking running, or playing a sport.

In step 705, a message is sent to the activity aggregator service with some or all fields of user activity data 510.

In step 707 it is determined if an audio summary of the activity for a user is requested. If not the process ends. Otherwise steps 709 through 715 are executed to download and render the activity summary audio stream and utilize any links therein. Any method may be used to determine if the audio summary is requested. For example, a user spoken command is issued response to an audio prompt on an audio interface unit. For example, a user moves the UE 101 to form a specific gesture in response to an audio or visual prompt, or the user activates a pointing device or types characters in response to a prompt or opens a web browser to go to web page where the audio stream is available.

If, it is determined, in step 707, that an audio summary of the activity for a user is requested, then in step 709 a message is sent to the activity summary service 170, requesting the audio summary of activity for the user. A standard web browser may be used to send this request. In some embodiment a personal audio client makes the request.

In step 711, the audio stream is received and rendered using any audio rendering module on the user device, such as a web browser or MP3 player or FM radio. Each portion of the audio stream is associated with a link at the activity summary service 170.

In step 713, it is determined whether the user has selected a link. Any method may be used to indicate this selection, such as moving the user device to form a specific gesture, speaking a command at the audio interface unit 160, or depressing one or more keys or touch screen areas on the UE 101 while the portion of the audio stream associated with the link is being rendered. If not, then the process ends.

If it is determined, in step 713, that the user has selected a link, then in step 715, the link is utilized based on an action by the user. For example, the link is bookmarked on a browser or other application for later use. Alternatively, a browser or other application is opened to access the network resource indicated by the link, such as a web page, content source, or messaging center.

With the system 100 described herein, an audio-based content delivery with full personalization is provided that offers the comfortable experience of listening to a favorite radio station during a car ride or in bed. Radio, one of the oldest information sharing channels, can be a very intimate experience when a user listens to a preferred channel in the privacy of the user's own space. For any user who faces information overflow during the day, caused by thousands of social networking updates, tweets, etc., an audio summary at the end of the day is offered that is tuned for his/her personal needs. Furthermore, in some embodiments, this audio summary provides access to any network service, personal information management service, application, commercial site like a music store, or search results related to the activity being presented. This social network information is naturally expanded in some embodiments with personal content, like favorite blogs, podcasts and web articles/pages. Furthermore, in some embodiments, the audio summary provides links to web articles/pages/blogs and podcasts that the user couldn't finish reading before the user had to leave a user derive, such as a personal computer at home or office.

As shown above, the user can configure the audio summary. This summary can be configured according to several parameters, such as duration, circle of people included like family, friends, colleagues, relevance of presented items, topical interest, nearest (or farthest or both) geographic location and most (or least or both) similar activities, or other filters. In some embodiments, some artistic elements are incorporated in the presentation, like using the voice of known actors or actresses for a premium price in the text-to-speech engine, or music in the background that can connect to a source of the music, such as a web-based music store.

As described above, the system includes a central aggregator (e.g., activity aggregator module 473) with client and server backend (e.g., configure summary module 471) for configuring the aggregator. The aggregator, stores all incoming messages, tweets, etc. from the specified circle of the user, including for example family members, friends, colleagues, into an activity database 475. For simplicity, the data stored under the user ID based on the user's account on a primary social networking service, like OVI of NOKIA, INC.™ of Finland. Other sources of activity can also be indicated, in various embodiments, such as social network pages and web pages and of the friends, and blogs and podcasts of interest.

In some embodiments, the activities of the user are also included, such as what the user was doing over the time period, and even the content the user was browsing, reading, or otherwise rendering. In some embodiments, the user pre-configures the system to monitor certain blogs/websites and new RSS feeds of interest to the user. In some embodiments the activity summary client 173 is installed as a computer browser Plug-In that pushes the webpage content the user wants to continue reading to the central aggregator described above, and report other user actions.

Some devices can detect a user's presence and even determine what a user is doing. That information is often shared via the user's social networking site. From such information from a user's friends' devices, the user can be informed, for instance, that Friend 1 was flying to Hawaii, Friend 2 was engaged in a meeting all day, Colleague 1 has been on a conference, and the user's brother just returned home after two weeks of vacation. Such action recognition technology is getting more and more mature.

At the end of the day all relevant information is pulled together into a time sequence presented as an audio stream. In several embodiments, the user is allowed to pre-set several parameters that tell the system, for example, that every week day the user wants a 2 minutes summary at the end of the day. The system pulls together the relevant activities, the user's configured settings specifying the most relevant ones, and other learned relevance measures, such as learned frequent contacts and learned subject areas of interest. One configured option is to present similar things or opposite ones; e.g. if the user worked a long day, the user may prefer to hear the opposite—that the user's friend just left for a vacation.

Using text-to-speech synthesis technology with selected voice parameters, an audio stream is generated from the time sequence of activities. The user experience can be very calming and enjoyable with the both commercial and artistic advantages.

The system, in some embodiments, is able to embed into the audio stream background sounds, such as ambient noises, music and other sounds by determining certain semantic elements in the messages. For example, a music piece embedded as background is chosen by what the user's friend listened to while communicating with a social network service, such as while jogging and connected to Nokia Sports Tracker.

Every audio portion of the audio stream is actionable; meaning that when the background music is heard, with a hand gesture or some other interaction type, the user can activate a link, for example, that takes an application on the a user device to a music store where the music can be purchased and downloaded. Similarly, in some embodiments, when listening to a portion describing a posting by a friend, the user can make a bookmark with a hand gesture or other interaction and the next morning find a reminder in the user's calendar about the posting. This reminds the user to send a message to the friend. In some embodiments, with a different hand gesture or other interaction, the user can send to the friend a small poke so the friend knows that the user is listening to the friend's activities during the day.

In some embodiments, described above, the system can learn based on usage statistics. Thus after a while the user is presented with the most relevant people from his/her social network. In some embodiments, certain actions for certain people can be offered on the fly, while other content, such as longer music pieces, can be pre-fetched from the source, such as a music store.

The processes described herein for providing audio summary of activity for a user may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to provide audio summary of activity for a user as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps for audio summary of activity for a user.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to audio summary of activity for a user. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for audio summary of activity for a user. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for audio summary of activity for a user, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for delivery of audio summary of activity for a user to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set 900 upon which an embodiment of the invention may be implemented. Chip set 900 is programmed to support audio summary of activity for a user as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 900, or a portion thereof, constitutes a means for performing one or more steps of providing an audio summary of activity for a user.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein for audio summary of activity for a user. The memory 905 also stores the data associated with or generated by the execution of the inventive steps.

FIG. 10 is a diagram of exemplary components of a mobile terminal (e.g., handset) for communications, which is capable of operating in the system of FIG. 1, according to one embodiment. In some embodiments, mobile terminal 1000, or a portion thereof, constitutes a means for performing one or more steps of providing an audio summary of activity for a user. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the audio summary of activity for a user. The display 10 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 for audio summary of activity for a user. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating access, including granting access rights, to an interface to allow access to a service via a network, the service comprising:
tracking activity at one or more network sources associated with a user;
generating one audio stream that summarizes the activity over a particular time period; and
causing the audio stream to be delivered to a particular device associated with the user,
wherein a duration of a complete rendering of the audio stream is shorter than the particular time period.

2. A method of claim 1, wherein the particular time period is about one day.

3. A method of claim 1, further comprising receiving user input that indicates control of the audio stream.

4. A method of claim 1, wherein tracking activity comprises determining a time and content associated with an action at the one or more network sources, wherein the action is a member of a group comprising:
content that is rendered;
a communication with a contact;
an application that is executed;
a posting to a social network service by a subscriber who is associated with the user; and
data entered by the user.

5. A method of claim 1, wherein generating the audio stream further comprises converting text determined during tracking the activity into speech.

6. A method of claim 5, wherein converting text into speech further comprises converting text to a celebrity voice.

7. A method of claim 1, wherein generating the audio stream further comprises:
determining audio content related to a particular activity; and,
adding the audio content as background to a summary of the particular activity.

8. A method of claim 1, further comprising causing to be delivered a link to content related to at least a portion of the audio stream.

9. A method of claim 8, further comprising receiving user input that indicates action on the link.

10. A method of claim 1, wherein generating one audio stream that summarizes the activity further comprises
determining relevance for at least one of each activity or each portion of text associated with an activity; and,
generating the audio stream based only on at least one of a most relevant activity or a most relevant portion of text of the most relevant activity.

11. A method of claim 1, wherein the particular device is a mobile device.

12. An apparatus comprising:
at least one processor; and
at least one memory including computer program code,
the at least one memory and the computer program code configured to, with the at least one processor, cause the apparatus to perform at least the following,
track activity at one or more network sources associated with a user;
generate one audio stream that summarizes the activity over a particular time period; and
cause the audio stream to be delivered to a particular device associated with the user,
wherein a duration of a complete rendering of the audio stream is shorter than the particular time period.

13. An apparatus of claim 12, wherein to track activity further comprises to determine a time and text associated with an action at the one or more network sources, wherein the action is a member of a group comprising:
content that is rendered;
a communication with a contact;
an application that is executed;
a posting to a social network service by a subscriber who is associated with the user; and
data entered by the user.

14. An apparatus of claim 12, wherein to generate the audio stream further comprises to convert text determined during tracking the activity into voice.

15. An apparatus of claim 12, wherein the particular device is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

16. An apparatus of claim 12, wherein the particular device is an audio interface unit further comprising: user interface circuitry and user interface software configured to facilitate user control of at least some functions of the audio interface unit through use of a speaker and configured to respond to user input.

17. A computer-readable storage medium carrying one or more sequences of one or more instructions which, when executed by one or more processors, cause an apparatus to at least perform the following steps:
track activity at one or more network sources associated with a user;
generate one audio stream that summarizes the activity over a particular time period; and
cause the audio stream to be delivered to a particular device associated with the user,
wherein a duration of a complete rendering of the audio stream is shorter than the particular time period

18. A computer-readable storage medium of claim 17, wherein to track activity comprises to determine a time and text associated with an action at the one or more network sources, wherein the action is a member of a group comprising:
content that is rendered;
a communication with a contact;
an application that is executed;
a posting to a social network service by a subscriber who is associated with the user; and
data entered by the user.

19. A computer-readable storage medium of claim 17, wherein to generate the audio stream further comprises converting text determined during tracking the activity into voice.

20. A computer-readable storage medium of claim 17, wherein the apparatus is caused, at least in part, to further cause to be delivered a link to content related to at least a portion of the audio stream.
